(19) United States
(12) Patent Application Publication
(10) Pub. No.: US 2022/0351052 A1
(43) Pub. Date: Nov. 3, 2022

(54) LEARNING APPARATUS, ESTIMATION APPARATUS, LEARNING METHOD, ESTIMATION METHOD AND PROGRAM

(71) Applicant: NIPPON TELEGRAPH AND TELEPHONE CORPORATION, Tokyo (JP)

(72) Inventor: Tomoharu IWATA, Tokyo (JP)

(73) Assignee: NIPPON TELEGRAPH AND TELEPHONE CORPORATION, Tokyo (JP)

(21) Appl. No.: 17/761,049

(22) PCT Filed: Sep. 18, 2019
(86) PCT No.: PCT/JP2019/036650

§ 371 Date: Mar. 16, 2022

(51) Int. Cl. G06N 5/02

(52) U.S. Cl. CPC G06N 5/022; G06Q 30/0631

(57) ABSTRACT

A training apparatus includes a calculation unit that takes aggregate data obtained by aggregating history data representing a history of second objects for each first object from a predetermined viewpoint, auxiliary data representing auxiliary information regarding the second object, and partial history data that is a part of the history data as inputs and calculates a value of a predetermined objective function, which represents a degree of matching between co-occurrence information representing a co-occurrence relationship of two second objects, and the aggregate data, the auxiliary data, and the partial history data, and a derivative of the objective function with respect to a parameter, and an updating unit that updates the parameter such that the value of the objective function is maximized or minimized using the value of the objective function and the derivative calculated by the calculation unit.

### TECHNICAL FIELD

The present invention relates to a training apparatus, an estimation apparatus, a training method, an estimation method, and a program.

### BACKGROUND ART

Co-occurrence information representing a co-occurrence relationship such as whether or not a piece of information and another piece of information occur at the same time is known. Co-occurrence information is used, for example, in recommender systems, document clustering, and social network analysis. Specific examples of such co-occurrence information include, for example, information indicating the number of people who have purchased items A and B at the same time, information indicating the number of occurrences of words A and B in a document, and information indicating the number of people who have suffered from diseases A and B as a medical history.

Here, for example, data including personal information such as a purchase history and a medical history may sometimes not be disclosed as co-occurrence information in view of protecting privacy. On the other hand, aggregate data (for example, data indicating the number of purchases of each item) that is aggregated so as not to include privacy-related information may sometimes be disclosed. Thus, a method of estimating the number of co-occurrences from aggregate data has been proposed (see, for example, NPL 1).

### CITATION LIST

### Patent Literature

NPL 1: Aleksandra B. Slavkovic, Partial Information Releases for Condential Contingency Table Entries: Present and Future, Journal of Privacy and Condentiality (2009) 1, Number 2, pp. 253-264

### SUMMARY OF THE INVENTION

### Technical Problem

However, in the method proposed in the related art, for example, auxiliary data representing the description of an item has not been able to be used to estimate co-occurrence information. Therefore, the estimation accuracy of co-occurrence information may not always be high.

An embodiment of the present invention has been made in view of the above points and it is an object of the present invention to estimate co-occurrence information with high accuracy.

### Means for Solving the Problem

To achieve the object, a training apparatus according to an embodiment of the present invention includes a calculation unit configured to take aggregate data obtained by aggregating history data representing a history of second objects for each first object from a predetermined viewpoint, auxiliary data representing auxiliary information regarding the second object, and partial history data that is a part of the history data as inputs and calculate a value of a predetermined objective function, which represents a degree of matching between co-occurrence information representing a co-occurrence relationship of two second objects, and the aggregate data, the auxiliary data, and the partial history data, and a derivative of the objective function with respect to a parameter, and an updating unit configured to update the parameter such that the value of the objective function is maximized or minimized using the value of the objective function and the derivative calculated by the calculation unit.

### Effects of the Invention

Co-occurrence information can be estimated with high accuracy.

### BRIEF DESCRIPTION OF DRAWINGS

FIG. 1 is a diagram illustrating an example of a functional configuration of an estimation apparatus according to an embodiment of the present invention.

FIG. 2 is a flowchart showing an example of an estimation process according to the embodiment of the present invention.

FIG. 3 is a diagram showing an example of evaluation results.

FIG. 4 is a diagram illustrating an example of a hardware configuration of an estimation apparatus according to the embodiment of the present invention.

### DESCRIPTION OF EMBODIMENTS

Hereinafter, an embodiment of the present invention will be described. In the embodiment of the present invention, an estimation apparatus 10 that can estimate co-occurrence information with high accuracy when aggregate data, auxiliary data, and few history data are given will be described. Further, a training apparatus 20 for training a parameter for estimating co-occurrence information will also be described.

Here, the aggregate data is data into which history data is aggregated from a certain viewpoint (for example, from a viewpoint of the number of purchases of each item or the number of people who have suffered from each disease). Specific examples of the aggregate data include data indicating the number of purchases of each item and data indicating the number of people who have suffered from each disease.

The history data is data representing a history of second objects (for example, items or diseases) for each first object (for example, each user). Specific examples of the history data include data representing a history of items purchased by each user and data representing a history of diseases suffered by each user.

The auxiliary data is data representing auxiliary information regarding a second object. Specific examples of the auxiliary data include data representing information regarding features of an item (for example, the category, release date, and description) and data representing information regarding features of a disease (for example, the disease name and description).

In the embodiment described below, the history data is assumed to be a history of items purchased by each user as an example. However, this is only an example and the embodiment of the present invention can be similarly applied to the case where the history data is a history of diseases suffered by each user. The embodiment of the present invention can also be applied when the history data represents the number of occurrences (occurrence history) of a word in each document. That is, the embodiment of the present invention can be similarly applied to any history data representing the history of second objects for each first object.

### Theoretical Configuration

First, a theoretical configuration of the embodiment of the present invention will be described. Hereinafter, as an example, it is assumed that the total number of items (the number of types of items) is I and the items are assigned indices 1 to I. It is also assumed that the total number of users is U and the users are assigned indices 1 to U.

Here, it is assumed that the number of purchases of each item

y={yᵢ}ᵢ₌₁^{I} [Math. 1]

is given as aggregate data, Where yᵢ represents the number of users who have purchased an item i.

It is assumed that item information

S={sᵢ}ᵢ₌₁^{I} [Math. 2]

is given as auxiliary data, where sᵢ∈ R^{D} is a D-dimensional real vector representing the features of an item i. The features of an item may include any features of the item such as, for example, the category, release date, and description. D is the number of features of the item and sᵢ is a representation of D features regarding the item i as a D-dimensional real vector.

It is assumed that the purchase histories of a small number of users

R={rᵤ}ᵤ₌₁^{U*} [Math. 3]

are given as few history data. Here, it is assumed that U* is a number greatly smaller than U (that is, U*«U). It is also assumed that rᵤ∈ {0,1}^{I} is an I-dimensional binary vector and an i-th element rᵤᵢ is 1 (rᵤᵢ=1) when a user u has purchased an item i and 0 (rᵤᵢ=0) when the user u has not purchased the item i.

In the embodiment of the present invention, co-occurrence information

xᵢⱼ=(z_{i̅j̅}, z_{īj}, z_{ij̅}, zᵢⱼ) [Math. 4]

is estimated for all item pairs i, j∈ {1, . . . , I}, where

z_{i̅j̅} [Math. 5]

represents the number of users who have purchased neither an item i nor an item j,

z_{īj} [Math. 6]

represents the number of users who have not purchased the item i but have purchased the item j,

z_{ij̅} [Math. 7]

represents the number of users who have purchased the item i but have not purchased the item j, and zᵢⱼ represents the number of users who have purchased both the item i and the item j. Note that this zᵢⱼ represents the number of co-occurrences of the items i and j.

When the number of users zᵢⱼ who have purchased both the item i and the item j (that is, the number of co-occurrences zᵢⱼ) has been obtained, other elements (variables) included in the co-occurrence information xᵢⱼ can be estimated from the following equation (1) using yᵢ, yⱼ, and U.

[Math. 8]

z_{īj}=yⱼ−zᵢⱼ

z_{ij̅}=yᵢ−zᵢⱼ

z_{i̅j̅}=U−yᵢ−yⱼ+zᵢⱼ (1)

Therefore, in order to obtain the co-occurrence information xᵢⱼ, it is sufficient to estimate the number of co-occurrences zᵢⱼ alone. In this case, because zᵢⱼ is subject to a constraint shown in the following equation (2), zᵢⱼ is estimated such that it satisfies the constraint.

max(0, yᵢ+yⱼ−U)≤zᵢⱼ≤min(yᵢ, yⱼ) (2)

Thus, the case of estimating the number of co-occurrences zᵢⱼ will be described below. In the embodiment of the present invention, the number of co-occurrences zᵢⱼ is estimated such that it matches the given aggregate data y, auxiliary data S, and data R on a small number of histories. For example, a likelihood L shown in the following equation (3) can be used as an index value indicating the degree of matching at this time.

$$\begin{matrix}[ Math . 9 ] & \\ L ( X , Ψ ) = λ {\sum }_{i = 1}^{I} {\sum }_{j = i + 1}^{I} log p ( {x}_{ij} \vert {β}_{ij} ) + ( 1 - λ ) {\sum }_{i = 1}^{I} {\sum }_{j = i + 1}^{I} log p ( {x}_{ij}^{*} \vert {β}_{ij} ) & ( 3 )\end{matrix}$$

where

X={zᵢⱼ}_{i,j=1}^{I} [Math. 10]

is a co-occurrence count set, p(xᵢⱼ|βᵢⱼ) is the probability of the number of co-occurrences when βᵢⱼis given, and βᵢⱼ is a parameter calculated from auxiliary data S and the like and is expressed as follows.

βᵢⱼ=(y_{i̅j̅}, y_{īj}, y_{ij̅}, yᵢⱼ) [Math. 11]

In addition, Ψ is a parameter for obtaining βᵢⱼ (specifically, for example, a combination of a scalar parameter α and parameters of neural networks f₀(⋅), f₀₁(⋅), and f₁(⋅) which will be described later), λ is a hyperparameter, and x*ᵢⱼ is co-occurrence information calculated from the data R on the small number of histories.

By using the likelihood L shown in the above equation (3) as an objective function and estimating a parameter Ψ that maximizes the objective function under the constraint shown in the above equation (2) based on an optimization method, the number of co-occurrences zᵢⱼ can be estimated from p(xᵢⱼ|βᵢⱼ) using a parameter βᵢⱼ calculated from the parameter Ψ.

For example, a Dirichlet multinomial distribution shown in the following equation (4) can be used as the above probability p(xᵢⱼ|βᵢⱼ).

$$\begin{matrix}[ Math . 12 ] & \\ p ( {x}_{ij} \vert {β}_{ij} ) = \frac{U ! Γ ( {\sum }_{{i}^{′} , {j}^{′}} , {γ}_{{i}^{′} {j}^{′}} )}{Γ ( U + {\sum }_{{i}^{′} , {j}^{′}} {γ}_{{i}^{′} {j}^{′}} )} {\prod }_{{i}^{′} , {j}^{′}} \frac{Γ ( {z}_{{i}^{′} {j}^{′}} + {γ}_{{i}^{′} {j}^{′}} )}{{z}_{{i}^{′} {j}^{′}} ! Γ ( {γ}_{{i}^{′} {j}^{′}} )} & ( 4 )\end{matrix}$$

where Γ(⋅) represents a gamma function.

For example, a Poisson distribution or a multinomial distribution may be used instead of the Dirichlet multinomial distribution shown in the above equation (4). Here, for p(x*ᵢⱼ|βᵢⱼ), z_{i′j′} included in the above equation (4) is replaced with z*_{i′j′}. The same replacement is similarly applied to a Poisson distribution, a multinomial distribution, or the like. Here, z*_{i′j′} is the number of co-occurrences of items i′ and j′ calculated from the data R on the small number of histories.

The above parameter βᵢⱼ is calculated using a function that takes auxiliary information sᵢ and sⱼ included in the auxiliary data S as inputs. For example, neural networks f₀(⋅), f₀₁(⋅), and f₁(⋅) can be used for such a function. The parameter βᵢⱼ can be calculated by the following equations (5) to (8) using these neural networks f₀(⋅), f₀₁(⋅), and f₁(⋅).

[Math. 13]

y_{i̅j̅}=α(1−\hat{θ}ᵢ)(1−\hat{θ}ⱼ)+f₀(sᵢ, sⱼ) (5)

y_{īj}=α(1−\hat{θ}ᵢ)\hat{θ}ⱼ+f₀₁(sᵢ, sⱼ) (6)

y_{ij̅}=α\hat{θ}ᵢ(1−\hat{θ}ⱼ)=f₀₁(sⱼ, sᵢ) (7)

yᵢⱼ=α\hat{θ}ᵢ\hat{θ}ⱼ+f₁(sᵢ, sⱼ) (8)

where

$$\begin{matrix}[ Math . 14 ] & \\ {θ}_{i} = \frac{{y}_{i}}{U} & \end{matrix}$$

is an empirical purchase probability of the item i and α>0 is a scalar parameter.

Because the co-occurrence relationship of the items i and j remains unchanged under transposition, neural networks shown in the following equations (9) and (10) using this property may be used.

f₀(sᵢ, sⱼ)=ρ₀(φ₀(sᵢ)+φ₀(sⱼ)) (9)

f₁(sᵢ, sⱼ)=ρ₁(φ₁(sᵢ)+φ₁(sⱼ)) (10)

where ρ₀(⋅), φ₀(⋅), ρ₁(⋅), and φ₁(⋅) are neural networks.

Although the number of co-occurrences zᵢⱼ needs to satisfy the constraint shown in the above equation (2), z′ᵢⱼ can be naturally made satisfy the constraint shown in the above equation (2) by replacing zᵢⱼ as in the following equation (11).

$$\begin{matrix}[ Math . 15 ] & \\ {z}_{ij} = max ( 0 , {y}_{i} + {y}_{j} - U ) + \frac{min ( {y}_{i} , {y}_{j} ) - max ( 0 , {y}_{i} + {y}_{j} - U )}{1 + exp ( - {z}_{ij}^{′} )} & ( 11 )\end{matrix}$$

Thus, −∞<z′ᵢⱼ<∞ may be estimated instead of the number of co-occurrences zᵢⱼ by replacing zᵢⱼ as in the above equation (11).

### Functional Configuration

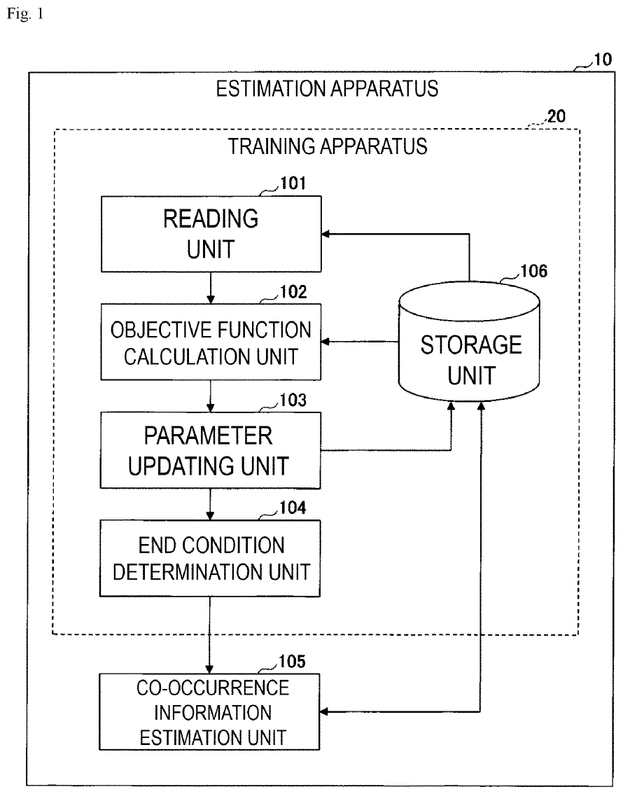

Hereinafter, a functional configuration of the estimation apparatus 10 according to the embodiment of the present invention will be described with reference to FIG. 1. FIG. 1 is a diagram illustrating an example of the functional configuration of the estimation apparatus 10 according to the embodiment of the present invention.

As illustrated in FIG. 1, the estimation apparatus 10 according to the embodiment of the present invention includes a reading unit 101, an objective function calculation unit 102, a parameter updating unit 103, an end condition determination unit 104, a co-occurrence information estimation unit 105, and a storage unit 106.

The storage unit 106 stores various data. The various data stored in the storage unit 106 include, for example, aggregate data, auxiliary data, few history data, and a parameter of an objective function (for example, the parameter Ψ of the likelihood L shown in the above equation (3)).

The reading unit 101 reads aggregate data y, auxiliary data S, and data R on a small number of histories stored in the storage unit 106. The reading unit 101 may read aggregate data y, auxiliary data S, and data R on a small number of histories, for example, by acquiring (downloading) them from a predetermined server apparatus or the like.

The objective function calculation unit 102 calculates a value of a predetermined objective function (for example, the likelihood L shown in the above equation (3)) and its derivative with respect to a parameter by using the aggregate data y, the auxiliary data S, and the data R on the small number of histories read by the reading unit 101. At this time, if there is a constraint (for example, the constraint shown in the above equation (2)), the objective function calculation unit 102 calculates the value of the objective function and the derivative under the constraint.

The parameter updating unit 103 updates the parameter such that the value of the objective function increases (or decreases) using the value of the objective function and the derivative calculated by the objective function calculation unit 102.

The end condition determination unit 104 determines whether or not a predetermined end condition is satisfied. The calculation of the objective function value and the derivative by the objective function calculation unit 102 and the parameter update by the parameter updating unit 103 are repeatedly executed until the end condition determination unit 104 determines that the end condition is satisfied. The parameter for estimating co-occurrence information is trained in this manner.

Examples of the end condition include that the number of repetitions exceeds a predetermined number, that the amount of change in the objective function value before and after a repetition is equal to or less than a predetermined first threshold value, and that the amount of change in the parameters before and after an update is equal to or less than a predetermined second threshold value.

The co-occurrence information estimation unit 105 estimates co-occurrence information xᵢⱼ using the trained parameter. For example, when the likelihood L shown in the above equation (3) is used as the objective function, the co-occurrence information estimation unit 105 can estimate the number of co-occurrences zᵢⱼ by the above equation (4). At this time, the co-occurrence information estimation unit 105 yields, for example, the number of co-occurrences zᵢⱼ having the highest probability as an estimation result. Using this, the co-occurrence information estimation unit 105 can estimate co-occurrence information xᵢⱼ by the above equation (1). The co-occurrence information estimation unit 105 does not necessarily have to estimate up to the co-occurrence information xᵢⱼ and may estimate only the number of co-occurrences zᵢⱼ.

Here, the training apparatus 20 is realized by the reading unit 101, the objective function calculation unit 102, the parameter updating unit 103, the end condition determination unit 104, and the storage unit 106. That is, the training apparatus 20 is realized by the functional units for training the parameter for estimating co-occurrence information (the reading unit 101, the objective function calculation unit 102, the parameter updating unit 103, and the end condition determination unit 104) and the storage unit 106.

The functional configuration of the estimation apparatus 10 illustrated in FIG. 1 is an example and the estimation apparatus 10 may have another functional configuration. For example, the estimation apparatus 10 and the training apparatus 20 may be realized by different devices and configured such that they can communicate with each other via a communication network or the like.

### Flow of Estimation Process

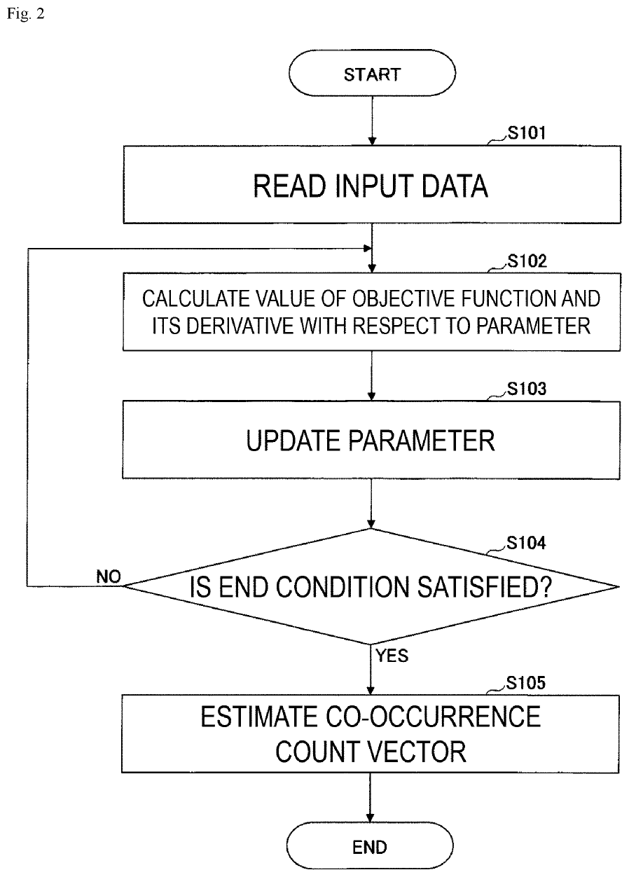

Hereinafter, a flow of an estimation process for training a parameter for estimating co-occurrence information and estimating co-occurrence information using the trained parameter will be described with reference to FIG. 2. FIG. 2 is a flowchart showing an example of the estimation process according to the embodiment of the present invention.

First, the reading unit 101 reads aggregate data y, auxiliary data S, and data R on a small number of histories stored in the storage unit 106 (step S101).

Next, the objective function calculation unit 102 calculates a value of a predetermined objective function (for example, the likelihood L shown in the above equation (3)) and its derivative with respect to a parameter by using the aggregate data y, the auxiliary data S, and the data R on the small number of histories read in step S101 above (step S102). At this time, if there is a constraint (for example, the constraint shown in the above equation (2)), the objective function calculation unit 102 calculates the value of the objective function and the derivative under this constraint.

Next, the parameter updating unit 103 updates the parameter such that the value of the objective function increases (or decreases) using the value of the objective function and the derivative calculated in step S102 above (step S103).

Next, the end condition determination unit 104 determines whether or not a predetermined end condition is satisfied (step S104). If it is not determined that the end condition is satisfied, the process returns to step S102. On the other hand, if it is determined that the end condition is satisfied, the process proceeds to step S106.

Finally, the co-occurrence information estimation unit 105 estimates co-occurrence information xᵢⱼ using the trained parameter (that is, the parameter updated by repeating the above steps S102 to S103) (step S105). As described above, the co-occurrence information estimation unit 105 estimates, for example, the number of co-occurrences zᵢⱼ having the highest probability as an estimation result by the above equation (4). Using this, the co-occurrence information estimation unit 105 can estimate co-occurrence information xᵢⱼ by the above equation (1).

### Evaluation

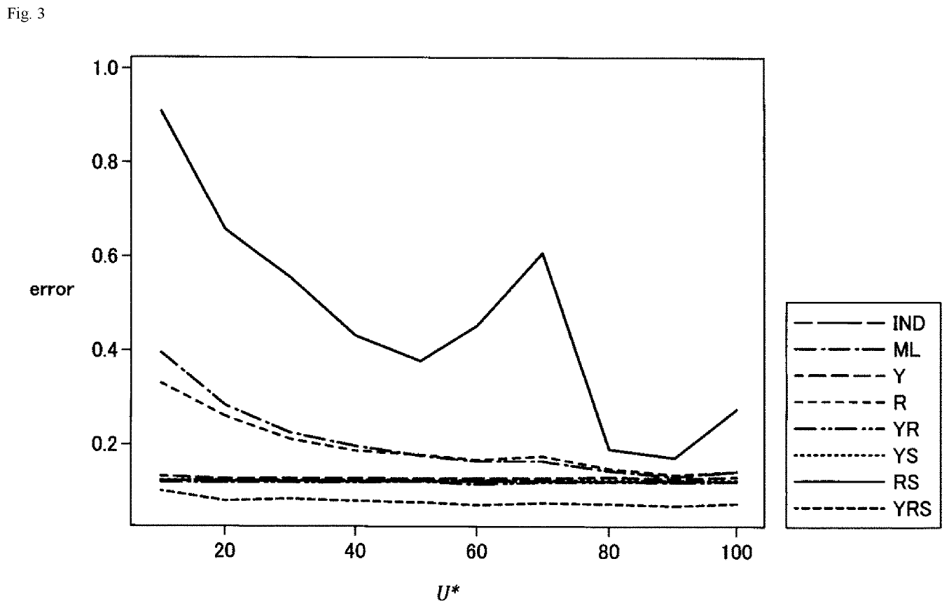

Hereinafter, evaluation of the embodiment of the present invention will be described. In order to evaluate the embodiment of the present invention, history data representing a history of items purchased by each user was used. Further, an error from the probability of the true number of co-occurrences obtained by actually calculating the number of co-occurrences using the purchase histories of all users was used as an evaluation index. FIG. 3 shows the evaluation results of evaluation targets.

The following are the evaluation targets.

IND: When the number of co-occurrences is estimated according to a conventional technology assuming that the purchases of items are independent of each other

ML: When the number of co-occurrences is estimated according to a conventional technology by maximizing the likelihood of the purchase histories of a small number of users

Y: When the number of co-occurrences is estimated according to the embodiment of the present invention using only the number of users who have purchased each item (that is, the aggregate data y)

R: When the number of co-occurrences is estimated according to the embodiment of the present invention using only the purchase histories of a small number of users (that is, the data R on the small number of histories)

YR: When the number of co-occurrences is estimated according to the embodiment of the present invention using the number of users who have purchased each item and the purchase histories of a small number of users

YS: When the number of co-occurrences is estimated according to the embodiment of the present invention using the number of users who have purchased each item and auxiliary information of each item (that is, the auxiliary data S)

RS: When the number of co-occurrences is estimated according to the embodiment of the present invention using the purchase histories of a small number of users and auxiliary information of each item

YRS; When the number of co-occurrences is estimated according to the embodiment of the present invention using the number of users who have purchased each item, the purchase histories of a small number of users, and auxiliary information of each item

As shown in FIG. 3, it can be seen that YRS has the smallest error. That is, it can be seen that the embodiment of the present invention can estimate the number of co-occurrences with high accuracy by using the aggregate data, the auxiliary data, and the few history data.

### Hardware Configuration

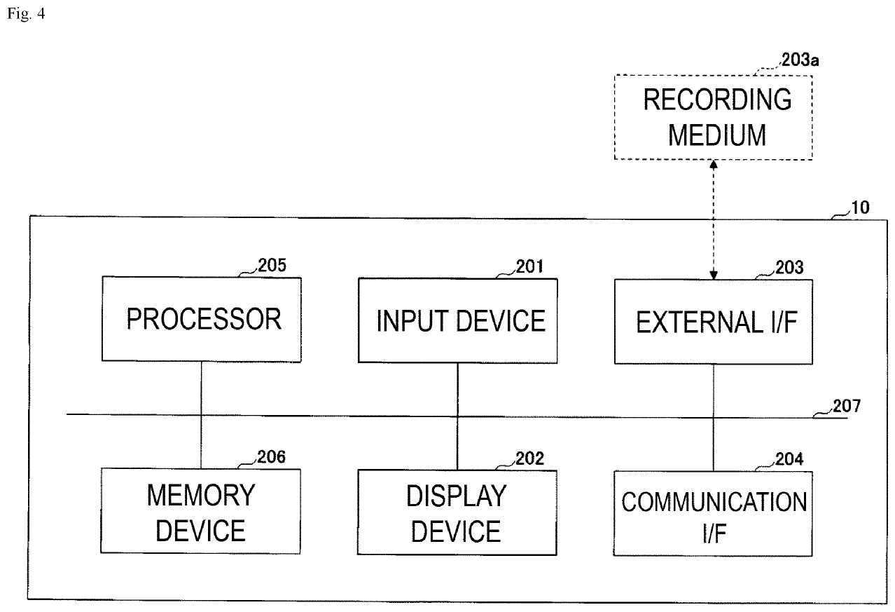

Finally, a hardware configuration of the estimation apparatus 10 according to the embodiment of the present invention will be described with reference to FIG. 4. FIG. 4 is a diagram illustrating an example of the hardware configuration of the estimation apparatus 10 according to the embodiment of the present invention. The training apparatus 20 can also be realized by the same hardware configuration as the estimation apparatus 10.

As illustrated in FIG. 4, the estimation apparatus 10 according to the embodiment of the present invention includes an input device 201, a display device 202, an external I/F 203, a communication I/F 204, a processor 205, and a memory device 206. These hardware components are communicatively connected via a bus 207.

The input device 201 is, for example, a keyboard, a mouse, or a touch panel and is used for a user to input various operations. The display device 202 is, for example, a display and displays a processing result or the like of the estimation apparatus 10. The estimation apparatus 10 may not include at least one of the input device 201 and the display device 202.

The external I/F 203 is an interface with an external apparatus. The external apparatus includes a recording medium 203a and the like. The estimation apparatus 10 can read from or write to the recording medium 203a via the external I/F 203. The recording medium 203a may record, for example, one or more programs that implement each functional unit of the estimation apparatus 10 (for example, the reading unit 101, the objective function calculation unit 102, the parameter updating unit 103, the end condition determination unit 104, and the co-occurrence information estimation unit 105).

Examples of the recording medium 203a include a compact disc (CD), a digital versatile disc (DVD), a secure digital (SD) memory card, and a universal serial bus (USB) memory card.

The communication I/F 204 is an interface for connecting the estimation apparatus 10 to the communication network. One or more programs that implement each functional unit of the estimation apparatus 10 may be acquired (downloaded) from a predetermined server apparatus or the like via the communication I/F 204.

The processor 205 is, for example, a central processing unit (CPU) or a graphics processing unit (GPU) and is an arithmetic unit that reads a program or data from the memory device 206 or the like and executes processing. Each functional unit of the estimation apparatus 10 is implemented by a process of causing the processor 205 to execute one or more programs stored in the memory device 206 or the like.

The memory device 206 is, for example, a hard disk drive (HDD), a solid state drive (SSD), a random access memory (RAM), a read only memory (ROM), or a flash memory and is a storage device for storing programs and data. The storage unit 106 included in the estimation apparatus 10 is implemented by the memory device 206 or the like.

The estimation apparatus 10 according to the embodiment of the present invention can realize the various processing described above by having the hardware configuration illustrated in FIG. 4. The hardware configuration illustrated in FIG. 4 is an example and the estimation apparatus 10 may have another hardware configuration. For example, the estimation apparatus 10 may have a plurality of processors 205 or may have a plurality of memory devices 206.

The present invention is not limited to the specific embodiment disclosed above and various modifications and changes can be made without departing from the scope of the claims.

### Reference List Signs

10 Estimation apparatus

20 Training apparatus

101 Reading unit

102 Objective function calculation unit

103 Parameter updating unit

104 End condition determination unit

105 Co-occurrence information estimation unit

106 Storage unit

1. A training apparatus comprising:
a processor; and
a memory storing computer-executable instructions configured to execute a method comprising:
determining aggregate data based on aggregating:
history data representing a history of second objects for each first object from a predetermined viewpoint,
auxiliary data representing auxiliary information regarding the second objects, and
partial history data that is a part of the history data as inputs;
calculating a value of a predetermined objective function, which represents a degree of matching between co-occurrence information representing a co-occurrence relationship of two second objects, and the aggregate data, the auxiliary data, and the partial history data, and a derivative of the predetermined objective function with respect to a parameter; and
updating the parameter such that the value of the predetermined objective function is maximized or minimized using the value of the predetermined objective function and the derivative.

2. The training apparatus according to claim 1, the computer-executable instructions further configured to execute a method comprising:
determining whether or not a predetermined end condition is satisfied; and
repeating the calculation of the value of the predetermined objective function and the derivative and the updating of the parameter until determining that the predetermined end condition is satisfied.

3. The training apparatus according to claim 1, wherein the history data include data representing a history of items purchased by each user, data representing a history of diseases suffered by each user, or data representing a number of occurrences of a word in each document, and
the auxiliary information regarding the second objects include information regarding a feature of the item, information regarding a feature of the disease, or information regarding a feature of the word.

4. The training apparatus according to claim 1, wherein the predetermined objective function is represented by a likelihood that uses a first probability distribution of the co-occurrence information and a second probability distribution of the co-occurrence information calculated from the partial history data when the parameter calculated from the auxiliary data is given.

5. (canceled)

6. A computer-implemented method for training, comprising:
determining aggregate data based on aggregating:
history data representing a history of second objects for each first object from a predetermined viewpoint,
auxiliary data representing auxiliary information regarding the second objects, and
partial history data that is a part of the history data as inputs
calculating a value of a predetermined objective function, which represents a degree of matching between co-occurrence information representing a co-occurrence relationship of two second objects, the aggregate data, the auxiliary data, the partial history data, and a derivative of the predetermined objective function with respect to a parameter; and
updating the parameter such that the value of the predetermined objective function is maximized or minimized using the value of the predetermined objective function and the derivative.

7. A computer-implemented method for estimating, the method comprising:
determining aggregate data based on aggregating:
history data representing a history of second objects for each first object from a predetermined viewpoint,
auxiliary data representing auxiliary information regarding the second objects, and
partial history data that is a part of the history data as inputs
calculating a value of a predetermined objective function, which represents a degree of matching between co-occurrence information representing a co-occurrence relationship of two second objects, the aggregate data, the auxiliary data, the partial history data, and a derivative of the predetermined objective function with respect to a parameter;
updating the parameter such that the value of the predetermined objective function is maximized or minimized using the value of the predetermined objective function and the derivative calculated in the calculation process; and
estimating the co-occurrence information using the updated parameter.

8. (canceled)

9. The training apparatus according to claim 2, wherein the history data include data representing a history of items purchased by each user, data representing a history of diseases suffered by each user, or data representing a number of occurrences of a word in each document, and
the auxiliary information regarding the second objects include information regarding a feature of the item, information regarding a feature of the disease, or information regarding a feature of the word.

10. The training apparatus according to claim 2, wherein the predetermined objective function is represented by a likelihood that uses a first probability distribution of the co-occurrence information and a second probability distribution of the co-occurrence information calculated from the partial history data when the parameter calculated from the auxiliary data is given.

11. The training apparatus according to claim 3, wherein the predetermined objective function is represented by a likelihood that uses a first probability distribution of the co-occurrence information and a second probability distribution of the co-occurrence information calculated from the partial history data when the parameter calculated from the auxiliary data is given.

12. The computer-implemented method according to claim 6, further comprising:
determining whether or not a predetermined end condition is satisfied; and
repeating the calculation of the value of the predetermined objective function and the derivative and the updating of the parameter until determining that the predetermined end condition is satisfied.

13. The computer-implemented method according to claim 6,
wherein the history data include data representing a history of items purchased by each user, data representing a history of diseases suffered by each user, or data representing a number of occurrences of a word in each document, and
the auxiliary information regarding the second objects include information regarding a feature of the item, information regarding a feature of the disease, or information regarding a feature of the word.

14. The computer-implemented method according to claim 6, wherein the predetermined objective function is represented by a likelihood that uses a first probability distribution of the co-occurrence information and a second probability distribution of the co-occurrence information calculated from the partial history data when the parameter calculated from the auxiliary data is given.

15. The computer-implemented method according to claim 7, further comprising:
determining whether or not a predetermined end condition is satisfied; and
repeating the calculation of the value of the predetermined objective function and the derivative and the updating of the parameter until determining that the predetermined end condition is satisfied.

16. The computer-implemented method according to claim 7,
wherein the history data include data representing a history of items purchased by each user, data representing a history of diseases suffered by each user, or data representing a number of occurrences of a word in each document, and
the auxiliary information regarding the second objects include information regarding a feature of the item, information regarding a feature of the disease, or information regarding a feature of the word.

17. The computer-implemented method according to claim 7, wherein the predetermined objective function is represented by a likelihood that uses a first probability distribution of the co-occurrence information and a second probability distribution of the co-occurrence information calculated from the partial history data when the parameter calculated from the auxiliary data is given.

18. The computer-implemented method according to claim 12, wherein the history data include data representing a history of items purchased by each user, data representing a history of diseases suffered by each user, or data representing a number of occurrences of a word in each document, and
the auxiliary information regarding the second objects include information regarding a feature of the item, information regarding a feature of the disease, or information regarding a feature of the word.

19. The computer-implemented method according to claim 12, wherein the predetermined objective function is represented by a likelihood that uses a first probability distribution of the co-occurrence information and a second probability distribution of the co-occurrence information calculated from the partial history data when the parameter calculated from the auxiliary data is given.

20. The computer-implemented method according to claim 13, wherein the predetermined objective function is represented by a likelihood that uses a first probability distribution of the co-occurrence information and a second probability distribution of the co-occurrence information calculated from the partial history data when the parameter calculated from the auxiliary data is given.

21. The computer-implemented method according to claim 15, wherein the history data include data representing a history of items purchased by each user, data representing a history of diseases suffered by each user, or data representing a number of occurrences of a word in each document, and
the auxiliary information regarding the second objects include information regarding a feature of the item, information regarding a feature of the disease, or information regarding a feature of the word.

22. The computer-implemented method according to claim 16, wherein the predetermined objective function is represented by a likelihood that uses a first probability distribution of the co-occurrence information and a second probability distribution of the co-occurrence information calculated from the partial history data when the parameter calculated from the auxiliary data is given.
